(19) United States
(12) Patent Application Publication
(10) Pub. No.: US 2022/0248041 A1
(43) Pub. Date: Aug. 4, 2022

(54) Pixel Block Encoder

(71) Applicant: Facebook Technologies, LLC, Menlo Park, CA (US)

(72) Inventors: Sudhir Satpathy, Redmond, WA (US); Richard Lawrence Greene, Redmond, WA (US); Cheng Chang, Redmond, WA (US)

(21) Appl. No.: 17/164,688

(22) Filed: Feb. 1, 2021

(51) Int. Cl. H04N 19/423; H04N 19/182; H04N 19/176

(52) U.S. Cl. CPC H04N 19/423; H04N 19/176; H04N 19/182

(57) ABSTRACT

In an embodiment, a method involves temporarily storing, by each of multiple slots of a ring buffer, a pixel block of multiple pixels blocks of an image until the pixel block is encoded, performing, by multiple processor units connected in series, different encoding operations in an encoding pipeline, each processor unit configured to selectively access the pixel block from a slot of the multiple slots to determine characteristics of the accessed pixel block, wherein the multiple processing units are configured to sequentially obtain access to a slot of the multiple slots and concurrently process the pixel blocks stored in different ones of the multiple slots, and selectively accessing and encoding, by an encoder unit, the pixel block stored in a slot of the multiple slots based on the characteristics of the pixel block determined by the multiple processing units.

### TECHNICAL FIELD

This disclosure generally relates to data compression, and, more specifically, to an architecture of a pixel encoding system.

### BACKGROUND

As digital media consumption increases so does the costs relating to memory or storage space and data transmission bandwidth. Thus, data compression is typically deployed as a conventional method for reducing data redundancy, and, by extension, reducing the consumption of memory or storage space and data transmission bandwidth. One particular type of data compression includes image data compression, in which image data is compressed by encoding an original image utilizing fewer bits than those utilized in the generation of the original image. In image data compression, the objective is to preserve most of the color information and other pertinent image information associated with the original image while mitigating the data redundancies. Desirably, any differences between the original image and the compressed image may be imperceptible to a user, for example, viewing the compressed image on a display. In this manner, the compressed image can then be stored and/or transmitted without an undesirable increase in costs such as memory or storage space and data transmission bandwidth. However, for certain types of images, utilizing conventional image data compression methods may lead to a decrease in the quality and perceptibility of the compressed image.

### SUMMARY OF PARTICULAR EMBODIMENTS

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The present embodiments are directed to a modular architecture of a pixel block encoder that leverages a ring buffer to process multiple pixel blocks in parallel and reduce computational costs by minimizing the data movement of the pixel blocks. The block encoder comprises a ring buffer and multiple processing units. The ring buffer includes multiple slots, each slot being used to temporarily store data corresponding to a single pixel block while the block is processed and encoded. The data stored in each slot is piped into each of the processing units in any desired order, but particular embodiments envisions piping in a sequential manner. At any given time, the multiple processing units could be working on different slots, allowing parallel processing of multiple pixel blocks. The pixel data stored in the slots are stored in the same slot until the data is fully encoded, at which time new pixel data corresponding to a different pixel block may be stored in the slot.

The various processing units of the encoder include: a “block-stats” unit that determines the statistical measurements of a pixel block (e.g., variance, channel priority) and the bit allocation of each channel of the pixel values; “endpoint” units that determine the optimal endpoints of the pixel encoding quantization levels (e.g., minimum and maximum values); and an “encode” unit that encodes each pixel in the pixel block based in part on the determined optimal endpoints. While the determinations of these processing units are communicated between each other (e.g., statistical measurements, optimal endpoints), there is no movement of pixel data between those processing units. Instead, the processing units access the pixel data that are stored in the slots to perform their respective analyses. This provides considerable reduction in computational costs by minimizing the overall data movement during the encoding process. In contrast, after the pixel block is encoded, the pixel data is transmitted to a “packetize” unit then to a “interleave” unit. The packetize unit assembles the encoded pixel data and corresponding header into packets. The interleave unit arranges the packets into a bitstream. In an embodiment, the “block-stats” unit may maintain a credit-based system to adjust the bit allocations assigned to each channel of pixel values of the pixel block.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example encoder system that leverages a ring buffer.

FIG. 2 illustrates an example slot of a ring buffer.

FIGS. 3A-3B illustrate a diagram of example operations of a block stats unit.

FIG. 4 illustrates a flow diagram of an example method of a block stats unit.

FIGS. 5A-5C illustrate examples of RGB histograms.

FIGS. 6A-6B illustrate example processes of encoding a pixel block.

FIG. 7 illustrates a diagram of example operations of an encoder system that leverages a ring buffer.

FIGS. 8A-8B illustrate an example artificial reality system.

FIG. 9 illustrates an example encoder-decoder (codec) system

FIG. 10 illustrates an example computer system.

### DESCRIPTION OF EXAMPLE EMBODIMENTS

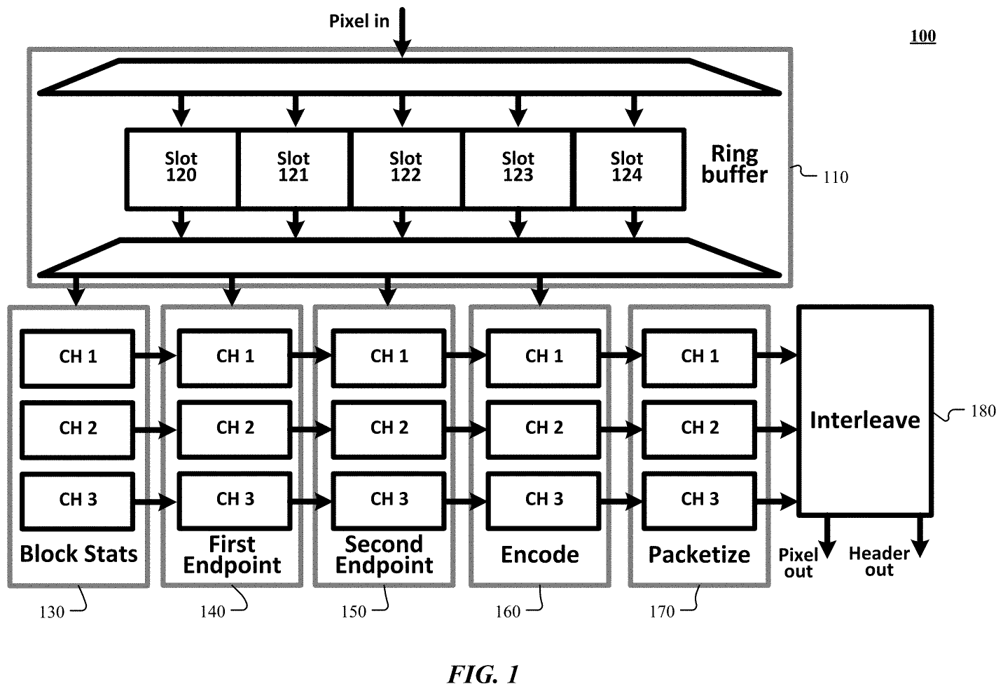

FIG. 1 illustrates an embodiment of a modular architecture of an encoder system 100 that leverages a ring buffer 120 to temporarily store multiple pixel blocks, or otherwise referred herein as pixel regions, such that the pixel blocks can be accessed by various processing units in parallel. Each pixel block may be accessed sequentially by the processing units from one of the slots of the ring buffer 120 until the pixel block is fully processed and encoded. In other words, data corresponding to the pixel blocks are not moved/transmitted during the encoding process. This allows substantial reduction in computational costs by minimizing the data movement of the pixel blocks.

In an embodiment, the encoder system 100 includes a 4-stage pipeline made up of various processing units. The processing units of the 4-stage pipeline include: a “block stats” unit 130 that determines statistical measurements of a pixel block (e.g., variance, channel priority) and the bit allocation of each channel of the pixel values; “first endpoint” and “second endpoint” units 140 and 150 that determine the optimal endpoints of the pixel encoding quantization levels (e.g., minimum and maximum values); and an “encode” unit 160 that encodes pixels in the pixel block based in part on the determined optimal endpoints. The architecture of the encoder system 100 allows pixel data to be stored and accessed from each of the slots of the ring buffer 110 during the encoding process, meaning that there is no movement of pixel data between the processing units 130, 140, 150, and 160. This provides considerable reduction in computational costs by minimizing the overall data movement during the encoding process. Instead, data corresponding to each pixel block is temporarily stored in one of the slots of the ring buffer 110 and made available to the processing units 130, 140, 150, and 160 until the pixel block is encoded, after which time the pixel data in the slot is removed or replaced by data corresponding to another pixel block. For example, pixel data stored in slot 120 could be accessed and processed, sequentially, by the block stats unit 130, the first endpoint unit 120, the second endpoint unit 130, then the encode unit 160. In some embodiments, the pixel data stored in slots may be accessed and processed selectively in a non-sequential manner. Once the encode unit 160 completes encoding the pixel data, the pixel data may then be deleted or removed from the slot 120, allowing data corresponding to anther pixel block to be stored in the slot 120.

At any given time, each of the processing units 130, 140, 150, and 160 could be processing data in different slots, allowing parallel processing of four different pixel blocks at once. While pixel data stored in the slots are not transmitted between the processing units 130, 140, 150, and 160, computations, calculations, and/or determinations made by the processing units may be shared amongst the processing units. For example, once the block stats unit 130 processes a pixel block and determines statistical measurements and bit allocations of the pixel block, these determinations may be provided to the first endpoint unit 140 and the second endpoint 150. The first and second endpoint units 140 and 150 may then determine the optimal endpoints of the pixel encoding quantization levels based in part on the information received from the block stats unit 130. Similarly, the encode unit 160 may process the pixel data based in part on the determinations made by the previous processing units. After the pixel block is encoded by the encode unit 160, the encoded pixel data is transmitted to a “packetize” unit 170 then to an “interleave” unit 180. The packetize unit 170 assembles the encoded pixel data and corresponding headers into packets, and the interleave unit 180 arranges the packets into a bitstream. The operations of the packetize unit 170 and the interleave unit 180 contrasts those involving the previous processing units (e.g., the processing units 130, 140, 150, and 160) in that pixel data may actually be transmitted between the encode unit 160, packetize unit 170 and interleave unit 180. The disclosure of this Application, when referencing the 4-stage pipeline, may include the operations of the packetize unit 170 and the interleave unit 180 within the 4-stage pipeline, as part of the final operations of the encoder system 100, for example, in combination with the operations of the encode unit 160.

The modular architecture of the encoder system 100 allows it to be flexible and easily configurable. In some embodiments, the 4-stage pipeline may be reduced to 3, 2, or less stages by removing or combining some of the processing units from the pipeline, for example, by combining the first and second endpoint units 140 and 150. Alternatively, the 4-stage pipeline may be increased to 5, 6, or more stages by including additional stages to the pipeline. In an embodiment, the number of total slots in the ring buffer may be configured to have one additional slot than the number of stages in the pipeline. For example, if the pipeline is modified to include 6 stages, the number of slot may be increased to 7 slot, allowing data stored in 6 of the slots to be accessed simultaneously and in parallel, while the last slot receives/stores, or prepares to receive/store, data corresponding to another pixel block.

The encoder system 100 is capable of processing various types of pixel data such as those corresponding to image colors, depth, and motion or optical flow. Depending on the type of data associated with the image, each pixel may have multiple components, or otherwise referred herein as channels. For example, if the type of pixel data corresponds to color values, each pixel may be associated the red, blue, and green components of RGB colors, Cb and Cr components for chrominance, or Y component for luminance. If the type of data corresponds to motion, each pixel may be associated with components corresponding to motion vector/field or optical flow vector/field. If the type of data corresponds to depth, each pixel may be associated with a depth component (e.g., z value). In the embodiment illustrated in FIG. 1, each of the processing units 130, 140, 150, 160, and 170 is configured with three sub-units (e.g., CH 1, CH 2, CH3), each sub-unit configured to process one channel of pixel data. This allows the encoder system 100 of the embodiment to process, for example, the three color channels of the RGB color values. In other embodiments, each of the processing units 130, 140, 150, 160, and 170 may be configured with the same or a fewer number of sub-units appropriate for processing the various components or channels of the pixel data. In some embodiments, the encoder system 100 may further process an additional channel of pixel values, i.e., an alpha component directed to the opaqueness of the pixels, separately from the processor units 130, 140, 150, 160, and 170. In such embodiments, the alpha values may first be transcoded into a format matching the encoded and packetized pixel values, then interleaved into a bitstream by the interleave unit 180. References to pixel channels within the disclosure of this Application may be used interchangeably with references to pixel components.

In an embodiment, the ring buffer 110 includes a slot pointer that specifies which slot is available to receive incoming pixel data of a pixel block. The incoming pixel data may be routed by a multiplexer to the appropriate slot. In an embodiment, each of the slots of the ring buffer 110 includes a processor pointer that specifies which processor unit data stored on the slot is being made available to. The pixel data stored in each of the slots may be routed to the appropriate processing unit by a multiplexer.

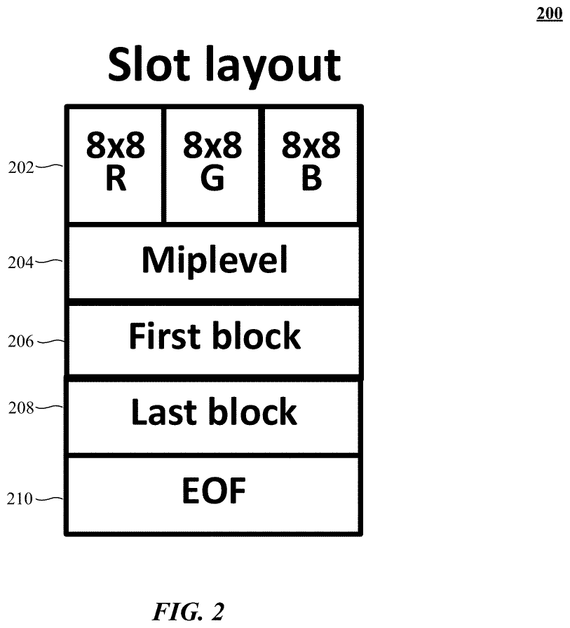

FIG. 2 illustrates an example configuration of a slot of a ring buffer. In an embodiment, each slot may be configured to store one or more channels of pixel data and additional metadata. For example, FIG. 2 illustrates a slot configured to store data corresponding to a pixel block comprising three channels of RGB color values 202 and additional metadata associated with the pixel block, including miplevel data 204 specifying where the pixel block falls under within a pre-calculated, lower-resolution representation of an image, first block data 206 indicating whether the pixel block is the first pixel block of a row of pixel blocks, last block data 208 indicating whether the pixel block is the last pixel block of the row of pixel blocks, end-of-file (EOF) data 210 indicating whether the pixel block is the last one of the image. Such metadata may be utilized at the end of the overall encoding process, for example, by the interleave unit 180 to arrange packets into a bitstream.

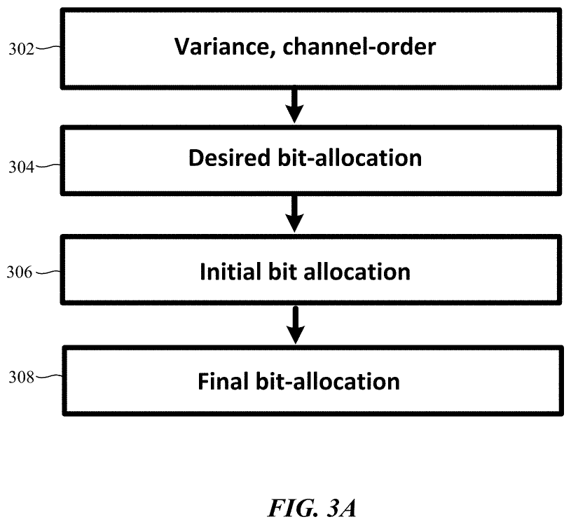

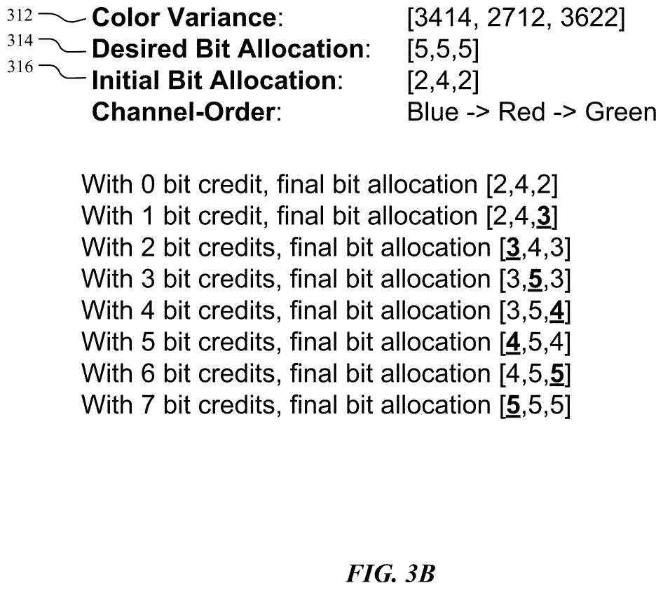

FIGS. 3A-3B illustrate a diagram of the operations of the block stats unit 130. In an embodiment, the block stats unit 130 selectively accesses data corresponding to a pixel block stored in one of the slots of the ring buffer 110. The block stats unit 130 processes and analyzes the pixel block to determine statistical measurements and the final bit allocation for each channel of the pixel values. The encoder system 100 of this disclosure presents techniques for encoding each of the RGB color channels separately. Thus, the block stats unit 130 is configured to determine separate statistical measurements and final bit allocation for each channel of pixel values, when applicable. It should be appreciated that the example techniques depicted in FIGS. 3A-3B are provided merely for illustration purposes. Disclosure of this Application may be described as being directed to the three channels of RGB color values, however, same or similar techniques may be applied to other types of pixel data described above. Moreover, the present techniques may be applied in the compression of any N-bit image, for example, a pixel region/block in an 8-bit color image, which may include RGB color channels/components.

Referring to FIG. 3A, the operations of the block stats unit 130 may begin at step 302 by determining the variance of the pixel values corresponding to each pixel channel and the channel-order for the pixel channels. The variance for each pixel channel of a pixel block is determined based on a mean (e.g., average) of the pixel values and a measure of the average degree to which the pixel values are different from the mean value. In general, higher variance means that there is a bigger spread of pixel values than those associated with lower variance. The channel-order specifies the prioritization of the pixel channels with respect to each other and is determined based on the variance of the pixel channels. For example, with respect to bit allocation, a pixel channel associated with higher variance may be prioritized before pixel channels associated with lower variance. At step 304, the block stats unit 130 determines the desired bit-allocation for each pixel channel based on the variance of the pixel values (e.g., bit allocation of [x, y, z]: “x” corresponding to the all of the red color components of the pixel region; “y” corresponding to the all of the green color components of the pixel region; and “z” corresponding to the all of the blue color components of the pixel region). In some embodiments, the desired bit-allocation for each pixel channel represents the number of bits required to encode the pixel values without any loss of information (i.e., lossless compression). At step 306, the block stats units 130 may determine the initial bit allocation based on a budget of bits allocated to each pixel channels of pixel blocks. For example, if each pixel block of an image is allocated a budget of 8 bits, the initial bit allocation represents the distribution of 8 bits across each pixel channel. At step 308, the block stats unit 130 determines the final bit-allocation for each of the pixel channels based on a credit-based system, which is explained in more detail below. An example processes of steps 302, 304, 306, and 308 are described next.

In an embodiment, the block stats unit 130 may begin analyzing a pixel block by calculating the color variances for each of the color components of the pixel block. For example, FIG. 3B illustrates an embodiment where the block stats unit 130 has determined that the red color component's variance is “3414”, the green color component's variance is “2712”, and the blue color component's variance is “3622,” i.e., [3414, 2712, 3622]. The block stats unit 130 may then utilize a rate-control technique to determine a desired bit allocation for each color component based on the number of bits required to fully represent the color values (e.g., color variance). In the embodiment of FIG. 3B, the block stats unit 130 has determined that the desired bit allocation should be [5, 5, 5], since that would fully capture the color values of the pixel block (i.e., red color component is allocated 5 bits; green color component is allocated 5 bits; blue color component is allocated 5 bits). Then, the block stats unit 130 determines the initial bit allocation for the pixel block based on a budget assigned to the pixel block, which may be predetermined based on a target compression rate of the image. For example, in the embodiment illustrated in FIG. 3B, the block stats unit 130 has determined that, with a budget of 8 bits for the pixel block, the initial bit allocation should be [2, 4, 2], i.e., 2 bits for the red color component, 4 bits for the green color component, and 2 bits for the blue color component. In some embodiments, the number of bits allocated to each of the color components may be based on factors other than the variance. For example, a higher number of bits may be allocated to the green color components to account for the fact that human eyes may be able to detect more shades of green than other colors.

In an embodiment, after the initial bit allocation has been configured, the block stats unit 130 may use a credit based technique to allocate additional bits to each color component. The credit based technique involves maintaining a credit pool that stores information on the total number of bits underutilized by pixel blocks (“bit credit”) so the underutilized bits can be provided to pixel blocks that require bit allocation in excess to the budget. For example, if pixel blocks of an image are each provided a budget of 8 bits, but the first pixel block only required 6 bits, then the underutilized 2 bits could be saved in the credit pool for any subsequent pixel blocks requiring more than the budget. On the other hand, if the desired bit allocation of a pixel block requires number of bits more than the budget, as illustrated in the embodiment of FIG. 3B, then the block stats unit 130 may allocate additional bits to the pixel block based on the availability of bit credits in the credit pool.

In an embodiment, the method of allocating available bit credits to a pixel block is based on the channel-order previously determined by the block stats unit 130. For example, in the embodiment of FIG. 3B, the channel-order has been determined as: (1) the blue color component, (2) the red color component, then (3) the green color component. If there are bit credits available to allocate to the pixel block, the bit credits are allocated by following the channel-order. FIG. 3B shows that available bit credits are first provided to the blue color component, then the red component, then the green components, then repeating the same distribution for additional bit credits until the credit pool is empty of bit credits or the desired bit allocation is reached. FIG. 3B also shows the final bit allocation based on the various number of available bit credits in the credit pool. Although not illustrated, in accordance with the presently disclosed techniques, in scenarios where more than 7 bit credits are available in the credit pool, the extra available bit credits remain in the credit pool to be utilized for one or more next pixel blocks.

The final bit allocation for each channel of the pixel block represents the bin count that the pixel values will be encoded based upon, or otherwise referred herein as the number of quantization levels. The encode unit 160 unit encodes pixel block based on the quantization levels, which process is explained more below. In an embodiment, if the final bit allocation matches the desired bit allocation, the number of quantization levels may match, or be greater than, the number of discrete pixel values, of a particular channel. This means that the pixel block may be encoded/compressed in a lossless fashion since there are enough quantization levels to represent each of the discrete pixel values. If the final bit allocation does not match the desired bit allocation, there may not be sufficient number of quantization levels to represent each of the discrete pixel values. This means that the pixel block may be encoded/compressed in a lossy fashion. In such cases, the encode unit 160 incorporates a scale to the encoding process so each quantization level could represent a group of discrete pixel values (e.g., a scale of 3 indicates that each quantization level represents 3 discrete pixel values).

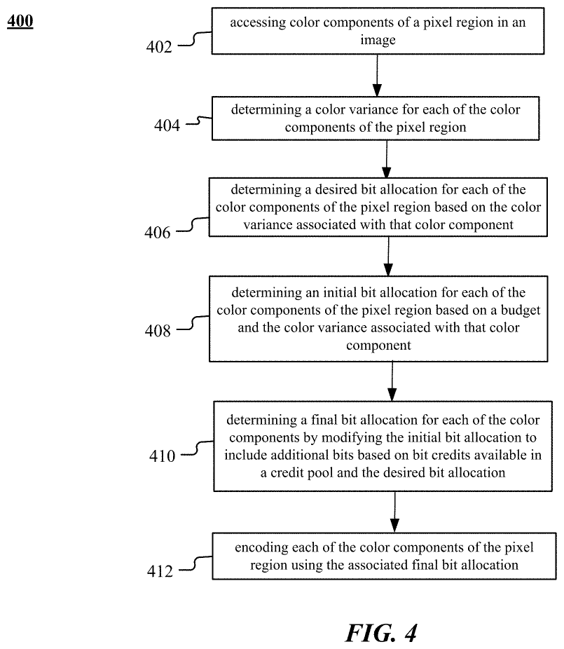

FIG. 4 illustrates is a flow diagram of a method 400 for encoding individual color components separately and providing a compression rate control method of allocating available bits to different RGB color components based on the amount of color information included in each of the three RGB color components of each pixel per pixel block, in accordance with the presently disclosed embodiments. The method 400 may be performed utilizing one or more processors (e.g., block stats unit 130) that may include hardware (e.g., a general purpose processor, a graphic processing units (GPU), an application-specific integrated circuit (ASIC), a system-on-chip (SoC), a microcontroller, a field-programmable gate array (FPGA), or any other processing device(s) that may be suitable for processing image data), software (e.g., instructions running/executing on one or more processors), firmware (e.g., microcode), or any combination thereof.

The method 400 may begin at block 402 with one or more processors (e.g., block stats unit 130) accessing color components of a pixel region in an image (e.g., a pixel block) from a slot of the ring buffer 110. For example, in one embodiment, the image may include an N-bit color image (e.g., 8-bit color image), which may include red (R) color components, green (G) color components, and blue (B) color components to be compressed and stored and/or transmitted, for example. The method 400 may continue at block 404 with the one or more processors (e.g., block stats unit 130) determining a color variance for each of the color components of the pixel region. For example, in certain embodiments, the block stats unit 130 may perform a pre-analysis of the of the N-bit color image (e.g., on a pixel region by pixel region basis) and determine a mean (e.g., an average of the total pixel value) and a variance (e.g., a measure of the average degree to which each RGB color component is different from the mean value) with respect to each of the RGB color components of each pixel per pixel region. The block stats unit 130 may also determine the channel-order (e.g., prioritization of the color components), in accordance to the above embodiments.

The method 400 may then continue at block 406 with the one or more processors (e.g., block stats unit 130) determining a desired bit allocation for each of the color components of the pixel region based on the color variance associated with that color component. For example, in some embodiments, the block stats unit 130 may determine a desired bit allocation [x, y, z] (e.g., x—corresponding to the all of the red color components of the pixel region; y—corresponding to the all of the green color components of the pixel region; and z—corresponding to the all of the blue color components of the pixel region) for encoding each of the RGB color components of the pixel region based on the color variance associated with each of the RGB color components. The method 400 may then continue at block 408 with the one or more processors (e.g., block stats unit 130) determining an initial bit allocation for each of the color components of the pixel region based on a budget and the color variance associated with that color component. For example, in some embodiments, if a budget of 8 bits is assigned to each pixel block of an image and if red color component has the largest variance and blue and green color components have similar variances, then the block stats unit 130 may determine the initial bit allocation as [4, 2, 2].

The method 400 may then continue at block 410 with the one or more processors (e.g., block stats unit 130) determining a final bit allocation for each of the color components by modifying the initial bit allocation to include additional bits based on bit credits available in a credit pool and the desired bit allocation. Continuing the example above where the initial bit allocation was determined as [4, 2, 2], if the desired bit allocation is [5, 3, 3] and there are 3 or more bit credits available in a credit pool, then additional bits may be allocated to the color components so the final bit allocation matches the desired bit allocation.

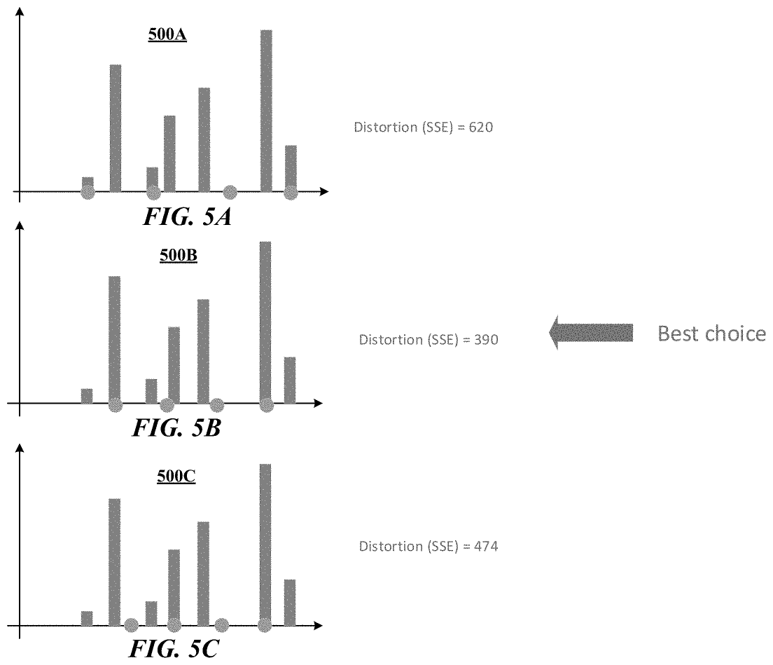

FIGS. 5A, 5B, and 5C illustrate RGB histograms 500A, 500B, and 500C representing the endpoint selection process performed by the first endpoint unit 140 and the second endpoint unit 150. In an embodiment, the encoding process requires each quantization level to be mapped to a specific pixel value or a group of pixel values. Depending on where the quantization levels are mapped to, the visual quality of the encoded pixel blocks could vary. Thus, the first endpoint unit 140 and the second endpoint unit 150 provides a method of determining optimal endpoint pixel values that the quantization levels could be mapped to. The method involves comparing several candidate endpoint values and selecting the endpoints that provides the minimum distortions (e.g., quantization error, measured using sum of squared errors (SSE)), thereby improving visual quality of the encoded and compressed images. This method can be visualized in the RGB histograms illustrated in FIGS. 5A, 5B, and 5C. The x-axis of the RGB histograms 500A, 500B, and 500C represents discrete pixel values, the y-axis represents the number of pixels associated with those particular pixel values, and the circles represent the placement of the quantization levels in association to particular pixel values of the x-axis.

In an embodiment, the first endpoint unit 140 selectively accesses pixel data stored in one of the slots of the ring buffer 110 to determine one of the endpoint values for the quantization levels. For each channel of the pixel block, the first endpoint unit 140 determines the first endpoint value by (1) fixing the second endpoint value to either the maximum or minimum pixel value, (2) selecting four candidate values for the first endpoint on the other end of the second endpoint, then (3) selecting the candidate value that results in the minimum quantization error. In some embodiments, more than, or less than, four candidate values may be selected. In some embodiments, determining whether to fix the second endpoint to the maximum or minimum pixel value depends on the distribution of the pixel values of the pixel block (of a particular pixel channel). If the distribution of the pixel values is skewed towards the higher end of the pixel values, the second endpoint may be fixed to the maximum pixel value and the candidate values for the first endpoint may be selected to include the minimum pixel value and several pixel values around the minimum value. If the distribution is skewed towards the lower end, the second endpoint may be fixed to the minimum pixel value and the candidate locations for the first endpoint may be selected to include the maximum pixel value and several pixel values around the maximum value.

In an embodiment, after selecting the candidate values for the endpoints, histograms may be computed for each pair of fixed endpoint and of the candidate endpoints and distortion produced by each pair could be compared to each other. Then, the candidate endpoint that produces the lowest distortion is selected as optimal. For example, FIGS. 5A, 5B, and 5C show three RGB histograms 500A, 500B, and 500C with three different pairs of endpoints. Between RGB histograms 500A (e.g., 620 SSE), 500B (e.g., 390 SSE), and 500C (e.g., 474 SSE), the RGB histogram 500B (e.g., 390 SSE) may be selected as the most optimal because the selection of the RGB histogram 500B (e.g., 390 SSE) leads to the lowest quantization error as compared to the RGB histogram 500A (e.g., 620 SSE) and the RGB histogram 500C (e.g., 474 SSE). Once the first optimal endpoint value is determined, the first optimal endpoint value is transmitted to the second endpoint unit 150 to allow the second endpoint unit 150 to determine the second endpoint value based on thereof.

In an embodiment, the second endpoint unit 150 selectively accesses pixel data stored in one of the slots of the ring buffer 110 to determine one of the endpoint values for the quantization levels. For each channel of the pixel block, the second endpoint unit 150 determines the second optimal endpoint value by (1) fixing the first endpoint value, which has been determined by the first endpoint unit 140 (2) selecting four candidate locations for the second endpoint value on the other end of the first endpoint (e.g., if the first endpoint corresponds to the maximum quantization level, then the second endpoint corresponds to the minimum quantization level, and vise versa), then (3) selecting the candidate location, in substantially the same manner as the operations of the first endpoint unit 140, that results in the minimum quantization error. In some embodiments, more, or less, than four candidate locations may be selected.

In an embodiment, once the first and second endpoints are selected for the quantization levels, the remaining quantization levels may be uniformly distributed between the endpoints, such as those illustrated in FIGS. 5A, 5B, and 5C. The first and second endpoints determined by the first and second endpoint units 140 and 150 may be transmitted to the encode unit 160.

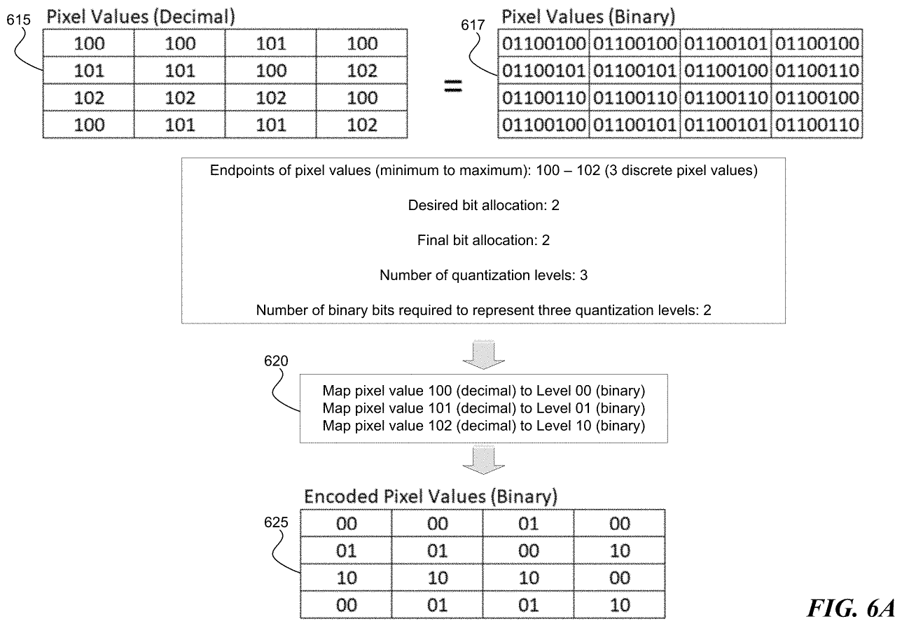

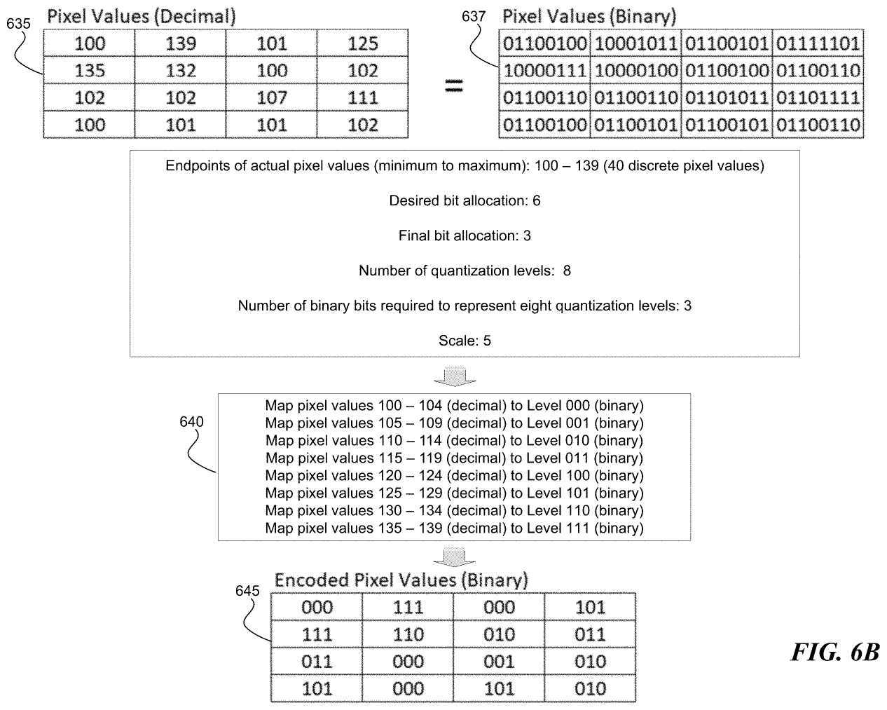

In an embodiment, once the block stats unit 130, the first endpoint unit 140, and the second endpoint unit 150 completes processing a pixel block, the encode unit 160 selectively accesses the pixel block from the slot of the ring buffer 110. Then, the encode unit 160 encodes the pixel block by leveraging the similarities between the pixel values within a pixel block to represent the pixel values with reduced number of binary bits. If the final bit allocation matches the desired bit allocation, the pixel values may be encoded in a lossless fashion such that each discrete pixel value within the pixel range is mapped to a specific quantization level. For example, FIG. 6A illustrates an example process of encoding a particular pixel channel of a pixel block 615 in a lossless fashion. The pixel block 615 comprises 3 discrete pixel values ranging from 100 to 102. Given that 3 discrete values can be represented by 2 binary bits, the desired bit allocation is determined as 2 bits. Assuming that the budget for this pixel block is 2 bits or more, the final bit allocation is also determined as 2 bits. Since the final bit allocation matches the desired bit allocation, each pixel value of the block can be encoded by mapping it to a corresponding quantization level, in accordance to the table 620, resulting in the encoded pixel block 625. This allows each of the pixel values to be represented by 2 binary bits instead of the 8 binary bits shown in the uncompressed pixel block 617. In an embodiment, the decoding process involves adding the encoded pixel values to an offset value (e.g., minimum pixel value of the uncompressed pixel array 715). In some embodiments, the encoder system 100 may maintain a look-up table that maps each quantization level to a pixel value, allowing the encoded pixel values to be decoded based on thereof and without division operations.

In an embodiment, if the final bit allocation does not match the desired bit allocation, the pixel values may be encoded in a lossy fashion such that each quantization level is mapped to a group of discrete pixel values. For example, FIG. 6B illustrates an example process of encoding a particular pixel channel of a pixel block 635 in a lossy fashion. The pixel block 615 comprises 40 discrete pixel values ranging from 100 to 139. Given that 40 discrete values can be represented by 6 binary bits, the desired bit allocation is determined as 6 bits. Assuming that the budget for this pixel block is 3 bits and no credits bits are available, the final bit allocation is determined as 3 bits. Since the final bit allocation does not match the desired bit allocation, a scale of 5 is incorporated to the quantization levels so a group of 5 discrete pixel values can be mapped to each quantization level, in accordance to the table 620, resulting in the encoded pixel block 645. This allows each of the pixel values to be represented by 3 binary bits instead of the 8 binary bits shown in the uncompressed pixel block 637. In an embodiment, the decoding process involves multiplying the encoded pixel values by the scale then adding them to an offset value (e.g., minimum pixel value of the uncompressed pixel array 635). In some embodiments, the encoder system 100 may maintain a look-up table that maps each quantization level to a pixel value, allowing the encoded pixel values to be decoded based on thereof and without division operations.

In an embodiment, after the encode unit 160 encodes a pixel block, the encoded pixel block is transmitted to the packetize unit 170 and the interleave unit 180, along with metadata computed by the block stats unit 130. Then, the packetize unit 170 assembles the encoded pixels and corresponding headers into packets and the interleave unit 180 arranges the packets into a bitstream, based in part on the metadata.

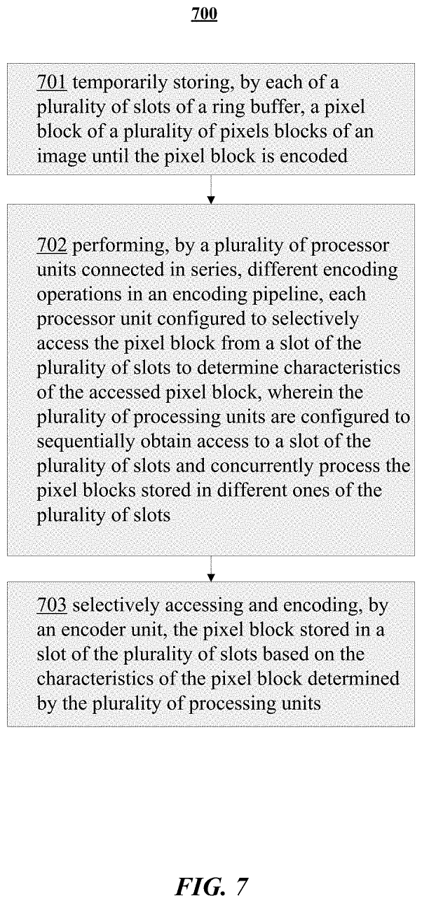

FIG. 7 illustrates an example method 700 for encoding an image by leveraging a ring buffer to process multiple pixel blocks in parallel and reduce computational costs by minimizing the data movement of the pixel blocks. The method may begin at step 701 by temporarily storing, by each of a plurality of slots of a ring buffer, a pixel block of a plurality of pixels blocks of an image until the pixel block is encoded. At step 702, the method may continue by performing, by a plurality of processor units connected in series, different encoding operations in an encoding pipeline, each processor unit configured to selectively access the pixel block from a slot of the plurality of slots to determine characteristics of the accessed pixel block, wherein the plurality of processing units are configured to sequentially obtain access to a slot of the plurality of slots and concurrently process the pixel blocks stored in different ones of the plurality of slots. At step 703, the method may continue by selectively accessing and encoding, by an encoder unit, the pixel block stored in a slot of the plurality of slots based on the characteristics of the pixel block determined by the plurality of processing units. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for encoding an image by leveraging a ring buffer to temporarily store multiple pixel blocks of the image to minimize data movement during the encoding process, this disclosure contemplates any suitable method for encoding an image by leveraging a ring buffer, including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

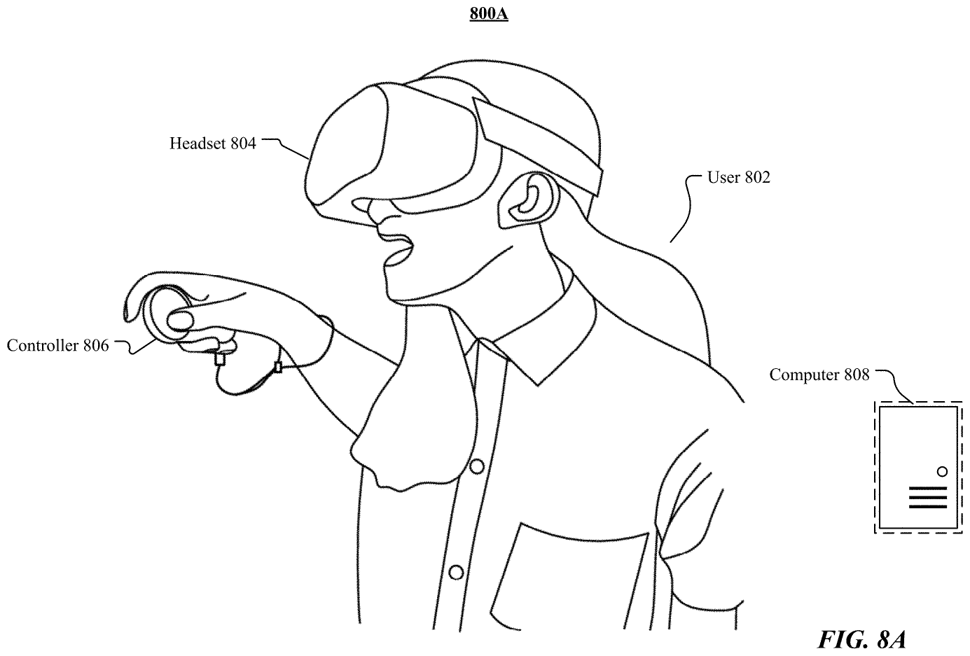

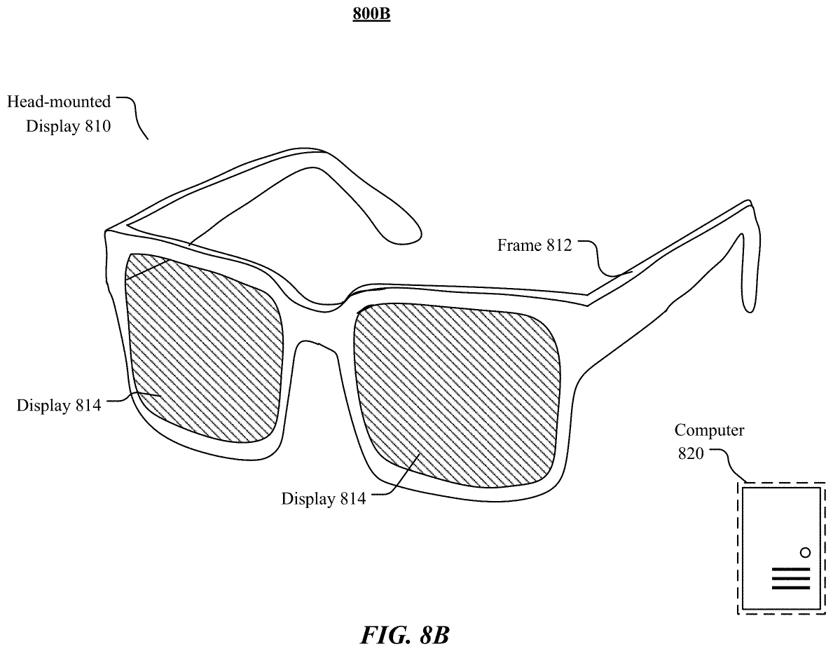

FIG. 8A illustrates an example artificial reality system 800A that may be useful in performing forgoing techniques as discussed herein, in accordance with the presently disclosed embodiments. In particular embodiments, the artificial reality system 800A may comprise a headset 804, a controller 806, and a computing system 808. A user 802 may wear the headset 804 that may display visual artificial reality content to the user 802. The headset 804 may include an audio device that may provide audio artificial reality content to the user 802. The headset 804 may include one or more cameras which can capture images and videos of environments. The headset 804 may include an eye tracking system to determine the vergence distance of the user 802. The headset 804 may be referred as a head-mounted display (HMD). The controller 806 may comprise a trackpad and one or more buttons. The controller 806 may receive inputs from the user 802 and relay the inputs to the computing system 808. The controller 806 may also provide haptic feedback to the user 802. The computing system 808 may be connected to the headset 804 and the controller 806 through cables or wireless connections. The computing system 808 may control the headset 804 and the controller 806 to provide the artificial reality content to and receive inputs from the user 802. The computing system 808 may be a standalone host computer system, an on-board computer system integrated with the headset 804, a mobile device, or any other hardware platform capable of providing artificial reality content to and receiving inputs from the user 802.

FIG. 8B illustrates an example augmented reality system 800B that may be useful in performing forgoing techniques as discussed herein, in accordance with the presently disclosed embodiments. The augmented reality system 800B may include a head-mounted display (HMD) 810 (e.g., glasses) comprising a frame 812, one or more displays 814, and a computing system 820. The displays 814 may be transparent or translucent allowing a user wearing the HMD 810 to look through the displays 814 to see the real world and displaying visual artificial reality content to the user at the same time. The HMD 810 may include an audio device that may provide audio artificial reality content to users. The HMD 810 may include one or more cameras which can capture images and videos of environments. The HMD 810 may include an eye tracking system to track the vergence movement of the user wearing the HMD 810. The augmented reality system 800B may further include a controller comprising a trackpad and one or more buttons. The controller may receive inputs from users and relay the inputs to the computing system 820. The controller may also provide haptic feedback to users. The computing system 820 may be connected to the HMD 810 and the controller through cables or wireless connections. The computing system 820 may control the HMD 810 and the controller to provide the augmented reality content to and receive inputs from users. The computing system 820 may be a standalone host computer system, an on-board computer system integrated with the HMD 810, a mobile device, or any other hardware platform capable of providing artificial reality content to and receiving inputs from users.

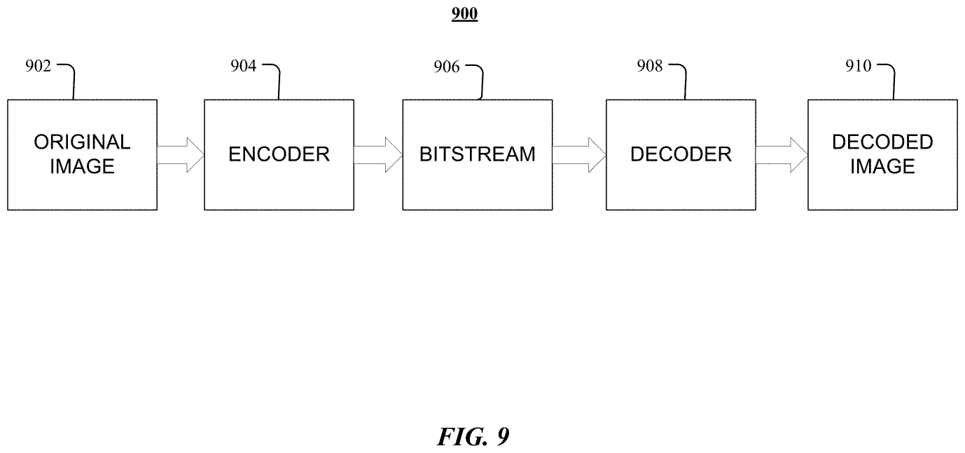

FIG. 9 illustrates an encoder-decoder (codec) system 900 that may be useful in performing forgoing techniques as discussed herein, in accordance with the presently disclosed embodiments. In some embodiments, the codec system 900 may be implemented as part of a subsystem on one or more general purpose processors, or may include a standalone graphic processing units (GPU), an application-specific integrated circuit (ASIC), a system-on-chip (SoC), a microcontroller, a field-programmable gate array (FPGA), or any other processing device(s) that may be suitable for processing image data. As depicted in FIG. 9, in some embodiments, the data flow of the codec system 900 may include receiving an original image 902 to be encoded via an encoder device 904, stored into a bitstream 906, and decoded via a decoder device 908 to generate a compressed and decoded image 910 to be stored and/or transmitted.

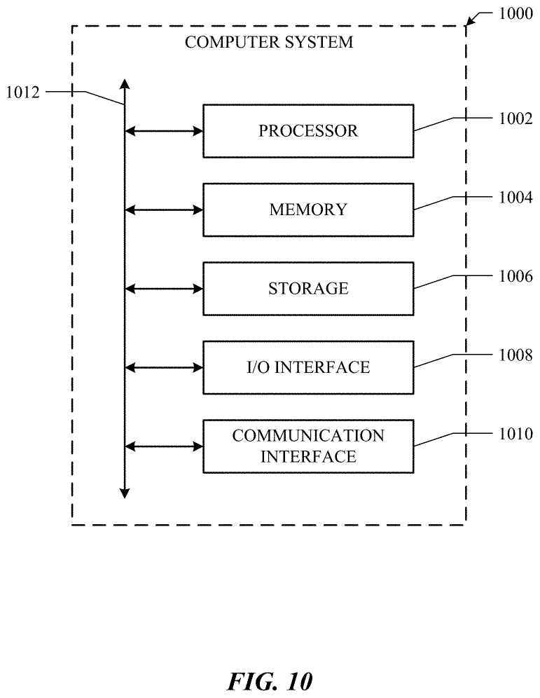

FIG. 10 illustrates an example computer system 1000 that may be useful in performing one or more of the foregoing techniques as presently disclosed herein. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein.

As an example, and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate. In certain embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In certain embodiments, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example, and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002.

Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 602. Although this disclosure describes and illustrates a particular processor, this disclosure contemplates any suitable processor.

In certain embodiments, memory 1004 includes main memory for storing instructions for processor 1002 to execute or data for processor 1002 to operate on. As an example, and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere).

One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example, and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In certain embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In certain embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In certain embodiments, communication interface 1010 includes hardware, software, or both providing one or more interfaces for communication (such as, for example, packet-based communication) between computer system 1000 and one or more other computer systems 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it.

As an example, and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In certain embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A system for encoding pixel blocks, comprising:
a ring buffer comprising a plurality of slots, each slot configured to temporarily store a pixel block of a plurality of pixels blocks of an image until the pixel block is encoded;
a plurality of processor units connected in series and configured to perform different encoding operations in an encoding pipeline, each processor unit configured to selectively access the pixel block from a slot of the plurality of slots to determine characteristics of the accessed pixel block, wherein the plurality of processing units are configured to sequentially obtain access to a slot of the plurality of slots and concurrently process the pixel blocks stored in different ones of the plurality of slots; and
an encoder unit configured to selectively access and encode the pixel block stored in a slot of the plurality of slots based on the characteristics of the pixel block determined by the plurality of processing units.

2. The system of claim 1, wherein the plurality of processor units comprises a first processor unit configured to determine a variance of pixel values of the accessed pixel block.

3. The system of claim 2, wherein the first processor is further configured to determine a final bit allocation for encoding the pixel values of the accessed pixel block.

4. The system of claim 1, wherein the plurality of processor units comprises a second processor unit and a third processor unit, each of the second and third processor units being configured to determine an endpoint value of the accessed pixel block.

5. The system of claim 1, further comprising a packetize unit configured to assemble the encoded pixel block into packets and an interleave unit configured to arrange the packets into a bitstream.

6. The system of claim 1, wherein the ring buffer comprises a write pointer configured to specify one or more slots that are available to receive and store a pixel block of the plurality of pixels blocks of the image.

7. The system of claim 1, wherein the ring buffer comprises a read pointer for each slot of the plurality of slots, each read pointer configured to specify one of the plurality of processing units or the encoder unit that the pixel block stored in the corresponding slot is being made available to.

8. A method for encoding pixel blocks, comprising:
temporarily storing, by each of a plurality of slots of a ring buffer, a pixel block of a plurality of pixels blocks of an image until the pixel block is encoded;
performing, by a plurality of processor units connected in series, different encoding operations in an encoding pipeline, each processor unit configured to selectively access the pixel block from a slot of the plurality of slots to determine characteristics of the accessed pixel block, wherein the plurality of processing units are configured to sequentially obtain access to a slot of the plurality of slots and concurrently process the pixel blocks stored in different ones of the plurality of slots; and
selectively accessing and encoding, by an encoder unit, the pixel block stored in a slot of the plurality of slots based on the characteristics of the pixel block determined by the plurality of processing units.

9. The method of claim 8, wherein the plurality of processor units comprises a first processor unit configured to determine a variance of pixel values of the accessed pixel block.

10. The method of claim 9, wherein the first processor is further configured to determine a final bit allocation for encoding the pixel values of the accessed pixel block.

11. The method of claim 8, wherein the plurality of processor units comprises a second processor unit and a third processor unit, each of the second and third processor units being configured to determine an endpoint value of the accessed pixel block.

12. The method of claim 8, further comprising:
assembling, by a packetize unit, the encoded pixel block into packets; and
arranging, by an interleave unit, the packets into a bitstream.

13. The method of claim 8, wherein the ring buffer comprises a write pointer configured to specify one or more slots that are available to receive and store a pixel block of the plurality of pixels blocks of the image.

14. The method of claim 8, wherein the ring buffer comprises a read pointer for each slot of the plurality of slots, each read pointer configured to specify one of the plurality of processing units or the encoder unit that the pixel block stored in the corresponding slot is being made available to.

15. One or more computer-readable non-transitory storage media storing instructions that, when executed by one or more processors included in one or more computing devices, cause the one or more computing devices to perform:
temporarily store, by each of a plurality of slots of a ring buffer, a pixel block of a plurality of pixels blocks of an image until the pixel block is encoded;
perform, by a plurality of processor units connected in series, different encoding operations in an encoding pipeline, each processor unit configured to selectively access the pixel block from a slot of the plurality of slots to determine characteristics of the accessed pixel block, wherein the plurality of processing units are configured to sequentially obtain access to a slot of the plurality of slots and concurrently process the pixel blocks stored in different ones of the plurality of slots; and
selectively access and encode, by an encoder unit, the pixel block stored in a slot of the plurality of slots based on the characteristics of the pixel block determined by the plurality of processing units.

16. The one or more computer-readable non-transitory storage media of claim 15, wherein the plurality of processor units comprises a first processor unit configured to determine a variance of pixel values of the accessed pixel block.

17. The one or more computer-readable non-transitory storage media of claim 16, wherein the first processor is further configured to determine a final bit allocation for encoding the pixel values of the accessed pixel block.

18. The one or more computer-readable non-transitory storage media of claim 15, wherein the plurality of processor units comprises a second processor unit and a third processor unit, each of the second and third processor units being configured to determine an endpoint value of the accessed pixel block.

19. The one or more computer-readable non-transitory storage media of claim 15 storing the instructions, when executed by the one or more processors, further cause the one or more computing devices to perform:
assemble, by a packetize unit, the encoded pixel block into packets; and
arrange, by an interleave unit, the packets into a bitstream.

20. The one or more computer-readable non-transitory storage media of claim 15, wherein the ring buffer comprises a read pointer for each slot of the plurality of slots, each read pointer configured to specify one of the plurality of processing units or the encoder unit that the pixel block stored in the corresponding slot is being made available to
